(19) United States
(12) Patent Application Publication
(10) Pub. No.: US 2024/0202738 A1
(43) Pub. Date: Jun. 20, 2024

(54) DIRECTING COMMUNICATIONS TO A DESTINATION

(71) Applicant: Microsoft Technology Licensing, LLC, Redmond, WA (US)

(72) Inventors: Ivan BARRIENTOS, Seattle, WA (US); Suhas RANGANATH, Bengaluru (IN); Daniel YEHDEGO, Bothell, WA (US); Kiran RAMA, Bangalore (IN)

(21) Appl. No.: 18/068,609

(22) Filed: Dec. 20, 2022

(51) Int. Cl. G06Q 30/015

(52) U.S. Cl. CPC G06Q 30/015

(57) ABSTRACT

A computing system collects customer support information about the customer support session including a transcript of communications associated with the customer support session. The computing system generates a routing score based on the customer support information about the customer support session using a machine learning model. The machine learning model is trained by training data from other customer support sessions, the training data from each other customer support session including a root cause indication qualified by customer input characterizing an outcome of that customer support session. The computing system identifies a destination for communicating the customer support report of the customer support session based on the routing score satisfying a routing condition for the destination. The customer support report includes some of the customer support information from the customer support session. The computing system directs communication of the customer support report for the customer support session to the identified destination.

### BACKGROUND

A user of technological devices and/or services can experience problems with such products. For example, a computing device may exhibit a hardware failure, or a software product may operate incorrectly or at least in a manner not anticipated or understood by the user. In such circumstances, the user may contact a customer support agent to obtain assistance with the problem. Such contact may be in the form of a customer support request (or “open ticket”) made by the client to the customer support agent, which typically contains a textual description of the problem.

In many such support scenarios, when the customer support request is closed with the customer, the customer support agent is likely to send a customer support report (or “closed ticket”) for the support session downstream to support teams who track and attempt to correct any problems with the product or service, such as in a future update. In many cases, the customer support agent attempts to identify the root cause of the problem and then manually decides where to route the support report for further processing. Such manual routing often results in reports being directed to the wrong support team (e.g., because of human error, incomplete information, an incorrect diagnosis). For example, a report about an apparent problem with a word processing application may be routed to the word processing application support team when the problem actually resulted from errors in the operating system or local/cloud storage access, which implicates a different support team. In many organizations, a large percentage of service requests are misrouted to the wrong support team, resulting in product support delays and costing considerable resources to review and re-route them. In some cases, the support team may not even know where to re-route the service request after it has determined that it was initially routed to the wrong support team.

### SUMMARY

In some aspects, the techniques described herein relate to a method of communicating a customer support report of a customer support session, the method including: collecting customer support information about the customer support session, the customer support information including a transcript of communications associated with the customer support session; generating a routing score based on the customer support information about the customer support session using a machine learning model, wherein the machine learning model is trained by training data from other customer support sessions, the training data from each other customer support session including a root cause indication qualified by customer input characterizing an outcome of that customer support session; identifying a destination for communicating the customer support report of the customer support session based on the routing score satisfying a routing condition for the destination, wherein the customer support report includes at least some of the customer support information from the customer support session; and direct communication of the customer support report for the customer support session to the identified destination.

In some aspects, the techniques described herein relate to a computing system for communicating a customer support report of a customer support session, the computing system including: one or more hardware processors; a collection interface executable by the one or more hardware processors and configured to collect customer support information about the customer support session, the customer support information including a transcript of communications associated with the customer support session; a scoring engine executable by the one or more hardware processors and configured to generate a routing score based on the customer support information about the customer support session using a machine learning model, wherein the machine learning model is trained by training data from other customer support sessions, the training data from each other customer support session including a root cause indication qualified by customer input characterizing an outcome of that customer support session; a router executable by the one or more hardware processors and configured to identify a destination for communicating the customer support report of the customer support session based on the routing score satisfying a routing condition for the destination, wherein the customer support report includes at least some of the customer support information from the customer support session; and a reporting engine executable by the one or more hardware processors and configured to direct communication of the customer support report for the customer support session to the identified destination.

In some aspects, the techniques described herein relate to one or more tangible processor-readable storage media embodied with instructions for executing on one or more processors and circuits of a computing device a process of communicating a customer support report of a customer support session, the process including: collecting customer support information about the customer support session, the customer support information including a transcript of communications associated with the customer support session; generating a routing score based on the customer support information about the customer support session using a machine learning model, wherein the machine learning model is trained by training data from other customer support sessions, the training data from each other customer support session including a root cause indication qualified by customer input characterizing an outcome of that customer support session; identifying a destination for communicating the customer support report of the customer support session based on the routing score satisfying a routing condition for the destination, wherein the customer support report includes at least some of the customer support information from the customer support session; and direct communication of the customer support report for the customer support session to the identified destination.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTION OF THE FIGURES

FIG. 1 illustrates an example customer support system.

FIG. 2 illustrates an example automatic closed ticket routing engine.

FIG. 3 illustrates example operations for training a machine learning model in a training phase to implement an automatic closed ticket routing engine.

FIG. 4 illustrates example operations for using a trained machine learning model in a prediction phase to automatically route customer support reports.

FIG. 5 illustrates an example computing device for use in deferred formula computation.

### DETAILED DESCRIPTION

The described technology supplements or replaces the error-prone manual routing of customer support reports performed by various customer support resources. In some implementations, a supervised-task deep learning framework is built on annotated data collected from multiple instances of support sessions between customers and one or more customer support resources about a customer problem. An inductive bias is also introduced to enhance the value/confidence of root cause indications provided by the customer support resources. As such, dependence on human-provided ground truth provided about a customer support session is eliminated or diminished to automate the accurate routing to a product/service support team designated to address the particular customer-experienced problem.

An automated routing determination is accomplished using customer support information from a customer support session (e.g., which may include multiple support session instances over time about the same issue), including without limitation available data characterizing the user's problem, attempted corrective steps, and/or any resolutions resulting from a customer support session. Communications between the customer and the support resource are captured and converted into a textual format (e.g., using transcripts of queries, emails, chats, texts, and/or phone/video communications) and included as customer support information in a customer support report.

For example, a customer may submit a support request (SR) through a customer support portal where the customer briefly describes the problem they are experiencing, possibly selecting a support topic from a drop-down menu or entering a query. The portal may include without limitation a support query field, an index, or another interface (examples of customer support resources) to present the customer with possible solutions to allow the customer to “self-resolve” the problem. If this support stage is unsuccessful, the customer can be directed to a chatbot to dig deeper into the problem and/or to a customer support agent (examples of other customer support resources).

After the customer support agent helps resolve the customer's service request, the agent indicates a root cause (RC) of the problem based on the support agent's diagnosis and resolution of the problem. This root cause also provides an initial indication of a product/service support team to which a report of the support session is to be sent for subsequent investigation and possible development efforts to reduce the probability that other customers encounter the same problem. For example, the product/service support team may develop and release a bug fix in a future release to prevent the problem from occurring again.

The customer is also asked to volunteer an indication of satisfaction (referred to as an “outcome indication” or a customer satisfaction score) with the outcome of the customer support session (e.g., on a scale of 1 to 5, from very unsatisfied to very satisfied). The outcome indication can be used to qualify the root cause indication. For example, if the user is satisfied with the customer support session, then the confidence in the agent's root cause indication is enhanced, or even labeled “correct”; if the user is dissatisfied with the customer support session, then the confidence in the agent's root cause indication is diminished, or even labeled “incorrect.” In this manner, the customer's satisfaction can be applied as a type of inductive bias to qualify or bias the root cause indication provided by the customer support resource.

In various implementations, the customer support information (e.g., the communication text, the root cause indication, the volunteered outcome indication) is input to a machine learning model to generate a destination score identifying a product/service support team to which the service request should be sent for further evaluation and/or processing. For example, one service request may be indicated by the customer support agent as having a root cause in the word processing product, but the communications text and/or the volunteered indication of satisfaction cause the machine learning model to automatically route the service request to the cloud storage support team. The textual elements of the customer support information, including root cause indications and outcome indications, are concatenated together to make the data compatible with natural language processing (e.g., for use in a BERT machine learning model).

Accordingly, correct customer support information (e.g., actual information from previous support sessions and/or information fabricated for training purposes) can be used to train, in a training phase, a machine learning model that is used for automated routing of customer support reports. Thereafter, the customer support information from current and/or future support sessions is input, in a prediction phase, to the trained machine learning model to automatically route the corresponding customer support report to a product support team or a service report team. This automated approach reduces the time it takes for a customer support report to get to the correct support team and reduces company resources (e.g., storage requirements, network bandwidth, personnel effort) used in processing closed service requests (customer support reports).

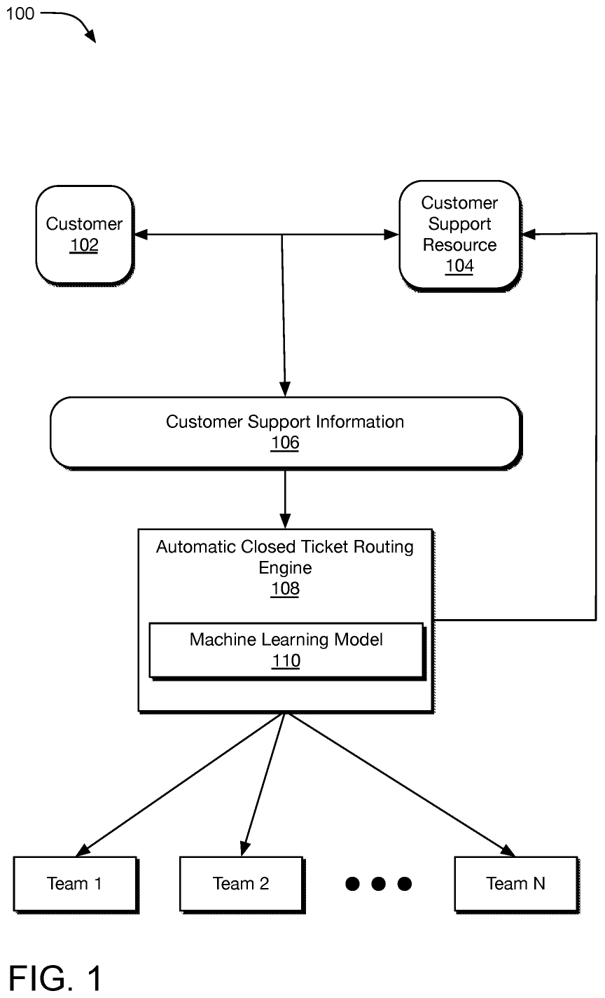

FIG. 1 illustrates an example customer support system 100. In a typical customer support session, a customer 102 contacts one or more customer support resources (e.g., customer support resource 104) for a product or service provider to get assistance with a problem. The customer support resource 104 may include without limitation one or more of a support bot (e.g., helping the customer 102 to query the problem and find possible articles on a similar type of problem), a support database (e.g., a FAQ webpage), and/or a customer support agent. For example, the customer 102 may call or use online chat to communicate with a telecommunication company's customer support agent in order to get assistance with a technical or billing problem regarding their phone service. The communications and support session notes recorded by the customer support resource 104 are collected as customer support information 106.

In various instances, the customer support information 106 may include a recording of the phone call, a transcription of the phone call, a transcript of the online chat, screenshots, support session notes, a root cause indication, an outcome indication, links to associated network resources (such as a support web page and/or an internal troubleshooting document), and/or other information relevant to the support session. A root cause indication represents an indication by the customer support resource 104 identifying the root cause of the customer's problem, as determined by the customer support resource 104. The outcome indication represents a scoring by the customer indicating the customer's satisfaction with the outcome of the customer support resource 104 (e.g., on a scale of 1-5, from dissatisfied to satisfied). The customer support information 106 can be captured from different sources (e.g., a phone system, a messaging system, assorted databases, data input from both the customer 102 and the customer support resource 104, etc. The customer support information 106 may include information from multiple customer support sessions on the same or similar problem or with the same customer. The customer support information 106 for the support session is collected into a customer support report in an automated closed ticket routing engine 108.

The automated closed ticket routing engine 108 includes a machine learning model 110 that has been trained by (real and/or fabricated) customer support information 106 representing information from “other” customer support sessions. The customer support information used as training data is combined (e.g., concatenated) with labels representing the correct destination to which the customer support report should be routed. For example, the customer support report about a customer asking for assistance for a word processing issue may be identified as a word processing root cause that should be labeled as being correctly routed to a support team for a word processing application (e.g., Team 1). On the other hand, in another similar scenario, the root cause may have correctly been identified as an operating system problem, so the customer support report for this similar support session should be labeled as being correctly routed to a support team for the operating system. Using such training data, the machine learning model 110 can learn to identify a correct team destination for different kinds of customer support reports, rather than merely relying on subjective, manual routing by the customer support resource 104. The training data for customer support reports with correct routing labels is deemed “labeled.”

A challenge of training the machine learning model 110 during a training phase is that the availability of correct labels for training data may be limited. For many customer support sessions, the customer support request is never paired with a correct label or ground truth. Instead, the customer support information for many support sessions is collected, but a root cause indication is not included in the customer support information (e.g., the support resource is unable to identify a root cause from the support session), an outcome indication is not included in the customer support information (e.g., the customer does not volunteer a level of satisfaction with the support session), and/or a downstream support team does not provide a final correct label indicating the correct support team. The training data for customer support reports without correct routing labels (or without reliable routing labels) is deemed “unlabeled.” Accordingly, in many implementations, the described technology is designed to provide one or more of the following capabilities:
to require relatively few likely-ground truth labels,
to scale well with thousands of unlabeled samples, and
to offer per-sample (e.g., local) interpretability.

In various implementations, a semi-supervised naïve Bayes classifier (NBC) is implemented to achieve automated routing in view of the desired capabilities given above. The basic idea is that for each document t, its words wₜ are count-vectorized to represent a bag of words; these count statistics for labeled and unlabeled documents are then used to define a loss function that is optimized through expectation maximization (EM). To define this loss function, the following notation is introduced. An index j (=1, . . . M) is used to enumerate classes, cⱼ for the class labels, index i to enumerate documents, xᵢ to denote a (vectorized) document, X_{L} for the set of labeled train documents, X_{U} for unlabeled documents used in training, for the space of training, X documents (a disjoint union of X_{L} and X_{U}), Y for the space of labels, and θ for the model parameters. In one implementation, the log loss function that is optimized via EM may be given as:

$$ℓ ( θ \vert X , Y ) = log P ( θ ) + {\sum }_{x ∈ {X}_{U}} log ( {\sum }_{j ∈ [ M ]} P ( {c}_{j} \vert θ ) P ( {x}_{i} \vert {c}_{j} ; θ ) ) \text{} + {\sum }_{x ∈ {X}_{L}} log P ( {y}_{i} = {c}_{j} \vert θ ) P ( {x}_{i} \vert {y}_{i} = {c}_{j} ; θ )$$

In one implementation, a long-sum-exp approach is used to compute the log of sums appearing in the middle term. Furthermore, count-scaling of data relative to the labeled train set and a vectorization technique (e.g., like apply_along_axis) can be employed to compute the loss function [symbol] (θ|X, Y), which acts as a supervised naïve Bayes classifier that is regularized by a clustering of unlabeled documents. The expectation maximization is applied as an optimization procedure, such that clustering may be interpreted as a form of K-means that is constrained by the labeled part of the loss function. Using this technique, or other similar implementations, the loss function employed in the machine learning model 110 can be trained to be accurate and scalable despite a relative scarcity of unlabeled samples.

Root causes for customer support reports are represented in databases as trees where depth is referred to as “level” with depth value d denoted by “Ld”. In some scenarios, L2 and L3 values tend to be the primary designators, in contrast to L1 and L4+ values. Because correctly predicting an L3 value implies a correct L2 value, the training of the machine learning model 110 focuses on the L3 level.

In one implementation, the machine learning model 110 includes separated models (one for each product support team) directed to multiple classes (e.g., five different root causes per model), although an integrated multiclass model for all product support teams or some combination thereof may be employed.

During a prediction phase, when identifying a product support team as the correct destination to which a specific customer support report is to be routed, an inductive bias is applied in the prediction phase based on the principle that a support request's true root cause is often captured by the following customer support information, some of which may be optional:
Brief customer statement: text provided by the customer in the customer support request submission
Cause text—text provided by a customer support resource regarding a likely cause or the initial customer experience leading to the support request
Resolution text—text provided by a customer support resource regarding a summary of steps taken to resolve the customer's problem
Symptoms text—text provided by a customer support resource regarding observations or clues that helped diagnose the customer's problem

As previously discussed, when the machine learning model 110 of the automated closed ticket routing engine 108 is attempting to identify the correct routing of the customer support report for the customer support session between the customer 102 and the customer support resource 104, the outcome indication volunteered by the customer 102 is used to qualify the root cause indication provided by the customer support resource 104. If the customer 102 indicates a high satisfaction with the support session, then confidence in the root cause indication is enhanced and/or the root cause indication is qualified as correct. In contrast, if the customer 102 indicates a low satisfaction with the support session, then confidence in the root cause indication is reduced and/or the root cause indication is qualified as incorrect.

In one implementation in the prediction phase, the machine learning model 110 generates a routing score based on the customer support information about the customer support session. The automated closed ticket routing engine 108 then determines whether the routing score satisfies a routing condition for a given destination (e.g., a product support team). A customer support report associated with customer support information having a generated routing score that best satisfies the routing condition of a destination across all available destinations is then routed to that identified destination. As used herein, the terms “best satisfies” or “better satisfying” represents a comparison of how well a customer support report satisfies the routing condition of a destination as compared to routing conditions of other available destinations. For example, if the routing condition is a threshold, the customer support report best satisfies the routing condition by exceeding the threshold of that routing condition the most, as compared to routing conditions for other destinations. In another example, if the routing condition is a clustering or distance metric, the customer support report best satisfies the routing condition by having the smallest clustering or distance metric, as compared to routing conditions for other destinations. Other implementations of “best satisfies” or “better satisfying” may be employed.

In some implementations, the customer support information may not be sufficient to generate a routing score with sufficient confidence to route the customer support result to any particular product support team. In such cases, the automated closed ticket routing engine 108 can request additional customer support information from the customer support resource 104, who can provide additional descriptive context, request additional information from the customer, etc. to supplement the inadequate customer support information.

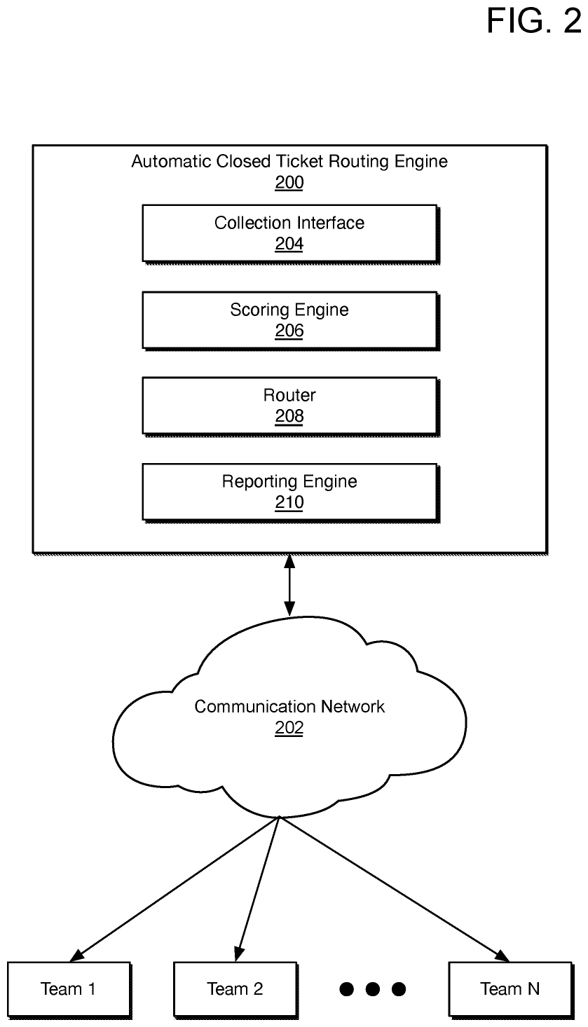

FIG. 2 illustrates an example automatic closed ticket routing engine 200. Multiple destinations (e.g., product support teams) are supported by the automatic closed ticket routing engine 200, which is communicatively coupled to the teams via a communication network 202. The automatic closed ticket routing engine 200 includes a collection interface 204 that collects customer support information about the customer support session. In some implementations, the customer support information includes without limitation a transcript of communications associated with the customer support session, a root cause indication, and/or an outcome indication (e.g., a customer satisfaction score).

The collection interface 204 inputs the collected customer support information into a scoring engine 206, which includes a machine learning model trained by training data from other customer support sessions. The training data from each other customer support session includes a root cause indication qualified by customer input characterizing an outcome of that customer support session.

A router 208 identifies a destination for communicating the customer support report of the customer support session based on the routing score determined by the scoring engine 206. In one implementation, the customer support report is routed to a destination for which the routing score best satisfies a routing condition corresponding to that destination. In other implementations, the customer support report is routed to any destination for which the routing score best satisfies the routing condition. A reporting engine 210 communicates the customer support report to the identified destination(s), such as via the communication network 202.

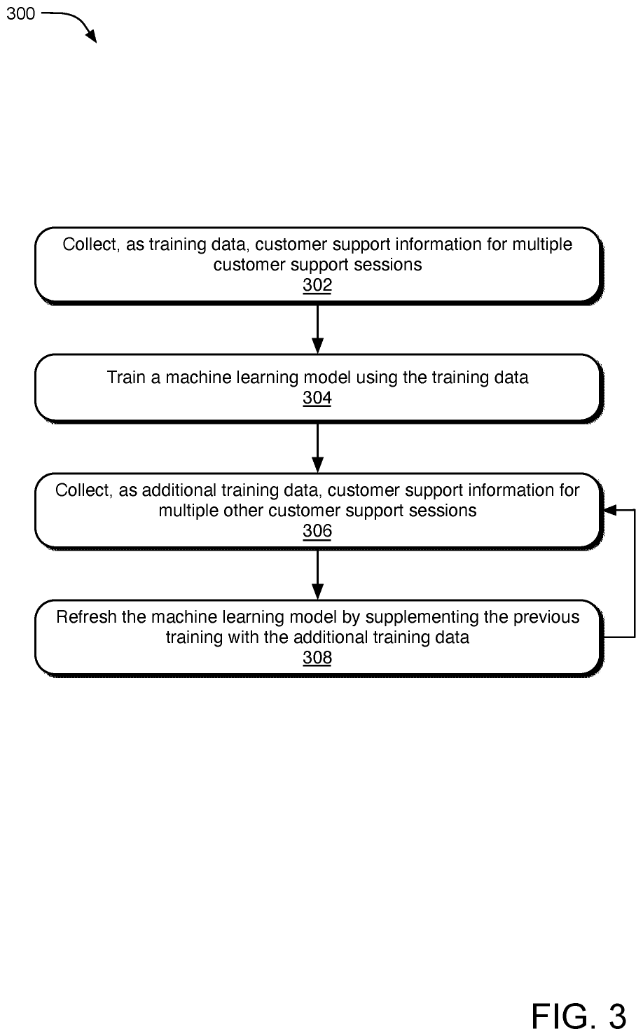

FIG. 3 illustrates example operations 300 for training a machine learning model in a training phase to implement an automatic closed ticket routing engine. A collection operation 302 collects training data including customer support information for multiple customer support sessions. This customer support information can be from actual historical customer support sessions and/or fictitious customer support information fabricated to train the machine learning model. The customer support information includes transcripts of communications associated with the customer support sessions, and customer support information for at least some of the customer support sessions includes labels indicating the correct destinations to send customer support reports for the corresponding customer support sessions. Some of the customer support information may not include labels; nevertheless, training using such unlabeled training data may be effective using the semi-supervised naïve Bayes classifier (NBC) approach described above.

A training operation 304 inputs the collected customer support information (with and without labels) into the machine learning model to train the model. In this training phase, at least some of the customer support information includes a root cause indication qualified by customer input characterizing an outcome of the corresponding customer support session.

The training operation 304 trains the machine learning model for use in a prediction phase. Nevertheless, the machine learning model can be updated or refreshed using supplemental customer support information, such as that for subsequently labeled support sessions (e.g., labeled by the downstream product support teams or other supervisory functions).

Accordingly, another collection operation 306 collects additional customer support information, which can be from different actual historical customer support sessions and/or fictitious customer support information fabricated to train the machine learning model. a refresh operation 308 updates the training of the machine learning model by training the model using the additional customer support information. The collection operation 306 and the refresh operation 308 may be repeated to continuously update the training of the machine learning model.

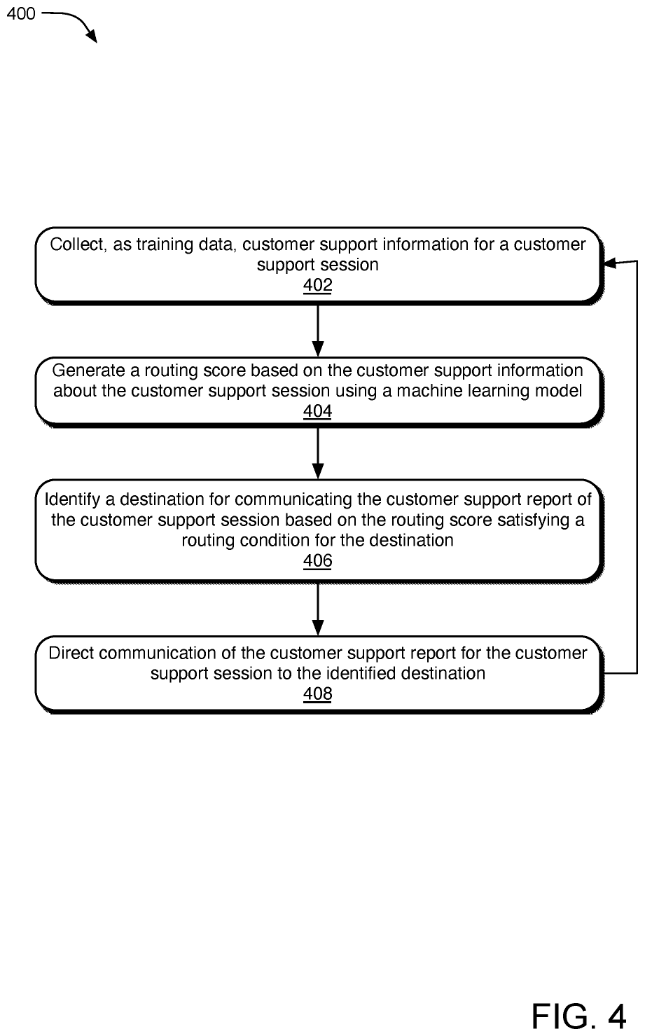

FIG. 4 illustrates example operations 400 for using a trained machine learning model in a prediction phase to automatically route customer support reports. A collection operation 402 302 collects training data including customer support information for multiple customer support sessions. This customer support information can be from actual historical customer support sessions and/or fictitious customer support information fabricated to train the machine learning model. The customer support information includes transcripts of communications associated with the customer support sessions, and customer support information for at least some of the customer support sessions includes labels indicating the correct destinations to send customer support reports for the corresponding customer support sessions. Some of the customer support information may not include labels; nevertheless, training using such unlabeled training data may be effective using the semi-supervised naïve Bayes classifier (NBC) approach described above.

A scoring operation 404 generates a routing score based on the customer support information about the customer support session using a machine learning model. The machine learning model is trained by training data from other customer support sessions, as discussed with reference to FIG. 3. The training data from each other customer support session includes a root cause indication qualified by customer input characterizing an outcome of that customer support session.

A routing operation 406 identifies a destination for communicating the customer support report of the customer support session based on the routing score satisfying a routing condition for the destination. The customer support report includes at least some of the customer support information from the customer support session. A communication operation 408 directs communication of the customer support report for the customer support session to the identified destination.

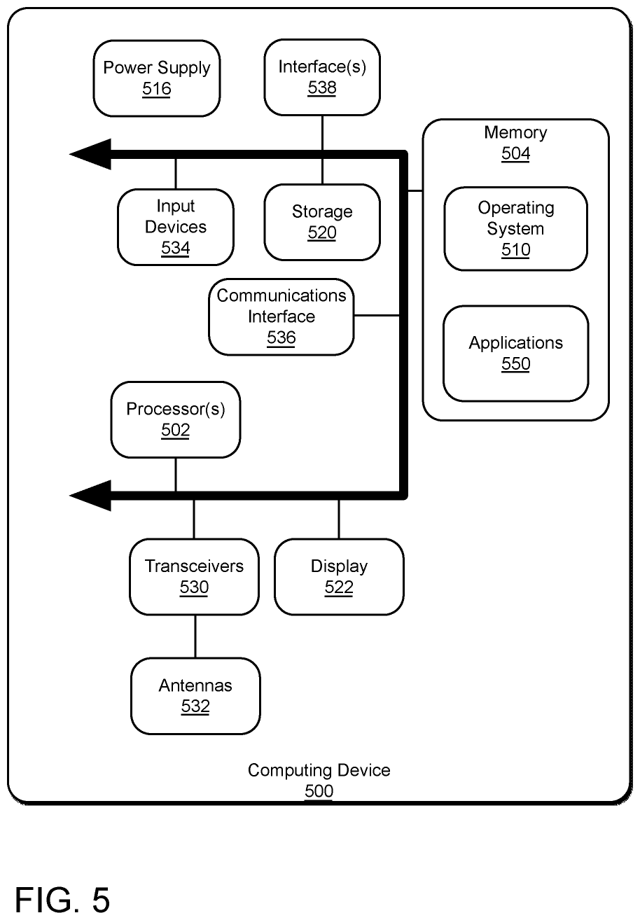

FIG. 5 illustrates an example computing device 500 for use in deferred formula computation. The computing device 500 may be a client device, such as a laptop, mobile device, desktop, tablet, or a server/cloud device. The computing device 500 includes one or more processor(s) 502, and a memory 504. The memory 504 generally includes both volatile memory (e.g., RAM) and nonvolatile memory (e.g., flash memory). An operating system 510 resides in the memory 504 and is executed by the processor(s) 502.

In the example computing device 500, as shown in FIG. 5, one or more modules or segments, such as applications 550, a collection interface, a scouring engine, a router, a reporting engine, and other program code and modules are loaded into the operating system 510 on the memory 504 and/or storage 520 and executed by processor(s) 502. The storage 520 may store customer support requests, customer support information, customer support reports, routing conditions, routing scores, and other data and be local to the computing device 500 or may be remote and communicatively connected to the computing device 500. In particular, in one implementation, components of an automatic closed ticket routing engine may be implemented entirely in hardware or in a combination of hardware circuitry and software.

The computing device 500 includes a power supply 516, which is powered by one or more batteries or other power sources, and which provides power to other components of the computing device 500. The power supply 516 may also be connected to an external power source that overrides or recharges the built-in batteries or other power sources.

The computing device 500 may include one or more communication transceivers 530, which may be connected to one or more antenna(s) 532 to provide network connectivity (e.g., mobile phone network, Wi-Fi®, Bluetooth®) to one or more other servers and/or client devices (e.g., mobile devices, desktop computers, or laptop computers). The computing device 500 may further include a communications interface 536 (such as a network adapter or an I/O port, which are types of communication devices). The computing device 500 may use the adapter and any other types of communication devices for establishing connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard or mouse). These and other input devices may be coupled to the server by one or more interfaces 538, such as a serial port interface, parallel port, or universal serial bus (USB). The computing device 500 may further include a display 522, such as a touchscreen display.

The computing device 500 may include a variety of tangible processor-readable storage media and intangible processor-readable communication signals. Tangible processor-readable storage can be embodied by any available media that can be accessed by the computing device 500 and can include both volatile and nonvolatile storage media and removable and non-removable storage media. Tangible processor-readable storage media excludes intangible communications signals (such as signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of communicating a customer support report of a customer support session, the method comprising: collecting customer support information about the customer support session, the customer support information including a transcript of communications associated with the customer support session; generating a routing score based on the customer support information about the customer support session using a machine learning model, wherein the machine learning model is trained by training data from other customer support sessions, the training data from each other customer support session including a root cause indication qualified by customer input characterizing an outcome of that customer support session; identifying a destination for communicating the customer support report of the customer support session based on the routing score satisfying a routing condition for the destination, wherein the customer support report includes at least some of the customer support information from the customer support session; and direct communication of the customer support report for the customer support session to the identified destination.

Clause 2. The method of clause 1, wherein the customer support information for the customer support session includes a root cause indication provided by a support resource.

Clause 3. The method of clause 1, wherein the customer support information for the customer support session includes an outcome indication provided by customer input.

Clause 4. The method of clause 1, wherein the training data from some of the other customer support sessions are labeled with correct destinations for communicating customer support reports for the some of the other customer support sessions.

Clause 5. The method of clause 1, wherein the training data from some of the other customer support sessions are not labeled with correct destinations for communicating customer support reports for the some of the other customer support sessions.

Clause 6. The method of clause 1, wherein the collected customer support information includes a root cause indication qualified by customer input characterizing an outcome of that customer support session.

Clause 7. The method of clause 1, wherein the identifying operation comprises: identifying the destination for communicating the customer support report of the customer support session based on the routing score better satisfying a routing condition for the destination as compared to routing conditions of other available destinations.

Clause 8. A computing system for communicating a customer support report of a customer support session, the computing system comprising: one or more hardware processors; a collection interface executable by the one or more hardware processors and configured to collect customer support information about the customer support session, the customer support information including a transcript of communications associated with the customer support session; a scoring engine executable by the one or more hardware processors and configured to generate a routing score based on the customer support information about the customer support session using a machine learning model, wherein the machine learning model is trained by training data from other customer support sessions, the training data from each other customer support session including a root cause indication provided by a customer support resource and qualified by an outcome indication provided by a customer for that customer support session; a router executable by the one or more hardware processors and configured to identify a destination for communicating the customer support report of the customer support session based on the routing score satisfying a routing condition for the destination, wherein the customer support report includes at least some of the customer support information from the customer support session; and a reporting engine executable by the one or more hardware processors and configured to communicate the customer support report for the customer support session to the identified destination.

Clause 9. The computing system of clause 8, wherein the customer support information for the customer support session includes a root cause indication provided by a support resource.

Clause 10. The computing system of clause 8, wherein the customer support information for the customer support session includes an outcome indication provided by customer input.

Clause 11. The computing system of clause 8, wherein the training data from some of the other customer support sessions are labeled with correct destinations for communicating customer support reports for the some of the other customer support sessions.

Clause 12. The computing system of clause 8, wherein the training data from some of the other customer support sessions are not labeled with correct destinations for communicating customer support reports for the some of the other customer support sessions.

Clause 13. The computing system of clause 8, wherein the collected customer support information includes a root cause indication qualified by customer input characterizing an outcome of that customer support session.

Clause 14. The computing system of clause 8, wherein the router is further configured to identify the destination for communicating the customer support report of the customer support session based on the routing score better satisfying a routing condition for the destination as compared to routing conditions of other available destinations.

Clause 15. One or more tangible processor-readable storage media embodied with instructions for executing on one or more processors and circuits of a computing device a process of communicating a customer support report of a customer support session, the process comprising: collecting customer support information about the customer support session, the customer support information including a transcript of communications associated with the customer support session; generating a routing score based on the customer support information about the customer support session using a machine learning model, wherein the machine learning model is trained by training data from other customer support sessions, the training data from each other customer support session including a root cause indication qualified by customer input characterizing an outcome of that customer support session; identifying a destination for communicating the customer support report of the customer support session based on the routing score satisfying a routing condition for the destination, wherein the customer support report includes at least some of the customer support information from the customer support session; and communicating the customer support report for the customer support session to the identified destination.

Clause 16. The one or more tangible processor-readable storage media of clause 15, wherein the customer support information for the customer support session includes a root cause indication provided by a support resource and an outcome indication provided by customer input.

Clause 17. The one or more tangible processor-readable storage media of clause 15, wherein the training data from some of the other customer support sessions are labeled with correct destinations for communicating customer support reports for the some of the other customer support sessions.

Clause 18. The one or more tangible processor-readable storage media of clause 15, wherein the training data from some of the other customer support sessions are not labeled with correct destinations for communicating customer support reports for the some of the other customer support sessions.

Clause 19. The one or more tangible processor-readable storage media of clause 15, wherein the collected customer support information includes a root cause indication qualified by customer input characterizing an outcome of that customer support session.

Clause 20. The one or more tangible processor-readable storage media of clause 15, wherein the identifying operation comprises: identifying the destination for communicating the customer support report of the customer support session based on the routing score better satisfying a routing condition for the destination as compared to routing conditions of other available destinations.

Clause 21. A system of communicating a customer support report of a customer support session, the system comprising: means for collecting customer support information about the customer support session, the customer support information including a transcript of communications associated with the customer support session; means for generating a routing score based on the customer support information about the customer support session using a machine learning model, wherein the machine learning model is trained by training data from other customer support sessions, the training data from each other customer support session including a root cause indication qualified by customer input characterizing an outcome of that customer support session; means for identifying a destination for communicating the customer support report of the customer support session based on the routing score satisfying a routing condition for the destination, wherein the customer support report includes at least some of the customer support information from the customer support session; and direct communication of the customer support report for the customer support session to the identified destination.

Clause 22. The system of clause 21, wherein the customer support information for the customer support session includes a root cause indication provided by a support resource.

Clause 23. The system of clause 21, wherein the customer support information for the customer support session includes an outcome indication provided by customer input.

Clause 24. The system of clause 21, wherein the training data from some of the other customer support sessions are labeled with correct destinations for communicating customer support reports for the some of the other customer support sessions.

Clause 25. The system of clause 21, wherein the training data from some of the other customer support sessions are not labeled with correct destinations for communicating customer support reports for the some of the other customer support sessions.

Clause 26. The system of clause 21, wherein the collected customer support information includes a root cause indication qualified by customer input characterizing an outcome of that customer support session.

Clause 27. The system of clause 21, wherein the means for identifying comprises: means for identifying the destination for communicating the customer support report of the customer support session based on the routing score better satisfying a routing condition for the destination as compared to routing conditions of other available destinations.

Some implementations may comprise an article of manufacture. An article of manufacture may comprise a tangible storage medium to store logic. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

1. A method of communicating a customer support report of a customer support session, the method comprising:
collecting customer support information about the customer support session, the customer support information including a transcript of communications associated with the customer support session;
generating a routing score based on the customer support information about the customer support session using a machine learning model, wherein the machine learning model is trained by training data from other customer support sessions, the training data from each other customer support session including a root cause indication qualified by customer input characterizing an outcome of that customer support session;
identifying a destination for communicating the customer support report of the customer support session based on the routing score satisfying a routing condition for the destination, wherein the customer support report includes at least some of the customer support information from the customer support session; and
directing communication of the customer support report for the customer support session to the identified destination.

2. The method of claim 1, wherein the customer support information for the customer support session includes a root cause indication provided by a support resource.

3. The method of claim 1, wherein the customer input is received from a customer of the customer support session and is applied as inductive bias to qualify the root cause indication provided by a customer support resource.

4. The method of claim 1, wherein the machine learning model is trained based on a loss function that acts as a semi-supervised naïve Bayes classifier.

5. The method of claim 1, wherein the training data from some of the other customer support sessions are not labeled with correct destinations for communicating customer support reports for the some of the other customer support sessions.

6. The method of claim 1, wherein the collected customer support information includes a root cause indication qualified by customer input characterizing an outcome of that customer support session.

7. The method of claim 1, wherein the identifying operation comprises:
identifying the destination for communicating the customer support report of the customer support session based on the routing score better satisfying a routing condition for the destination as compared to routing conditions of other available destinations.

8. A computing system for communicating a customer support report of a customer support session, the computing system comprising:
one or more hardware processors;
a collection interface executable by the one or more hardware processors and configured to collect customer support information about the customer support session, the customer support information including a transcript of communications associated with the customer support session;
a scoring engine executable by the one or more hardware processors and configured to generate a routing score based on the customer support information about the customer support session using a machine learning model, wherein the machine learning model is trained by training data from other customer support sessions, the training data from each other customer support session including a root cause indication provided by a customer support resource and qualified by an outcome indication provided by a customer for that customer support session;
a router executable by the one or more hardware processors and configured to identify a destination for communicating the customer support report of the customer support session based on the routing score satisfying a routing condition for the destination, wherein the customer support report includes at least some of the customer support information from the customer support session; and
a reporting engine executable by the one or more hardware processors and configured to communicate the customer support report for the customer support session to the identified destination.

9. The computing system of claim 8, wherein the customer support information for the customer support session includes a root cause indication provided by a support resource.

10. The computing system of claim 8, wherein customer input is received from a customer of the customer support session and is applied as inductive bias to qualify the root cause indication provided by the customer support resource.

11. The computing system of claim 8, wherein the machine learning model is trained based on a loss function that acts as a semi-supervised naïve Bayes classifier that is regularized by a clustering of unlabeled documents.

12. The computing system of claim 8, wherein the training data from some of the other customer support sessions are not labeled with correct destinations for communicating customer support reports for the some of the other customer support sessions.

13. The computing system of claim 8, wherein the collected customer support information includes a root cause indication qualified by customer input characterizing an outcome of that customer support session.

14. The computing system of claim 8, wherein the router is further configured to identify the destination for communicating the customer support report of the customer support session based on the routing score better satisfying a routing condition for the destination as compared to routing conditions of other available destinations.

15. One or more tangible processor-readable storage media embodied with instructions for executing on one or more processors and circuits of a computing device a process of communicating a customer support report of a customer support session, the process comprising:
collecting customer support information about the customer support session, the customer support information including a transcript of communications associated with the customer support session;
generating a routing score based on the customer support information about the customer support session using a machine learning model, wherein the machine learning model is trained by training data from other customer support sessions, the training data from each other customer support session including a root cause indication qualified by customer input characterizing an outcome of that customer support session;
identifying a destination for communicating the customer support report of the customer support session based on the routing score satisfying a routing condition for the destination, wherein the customer support report includes at least some of the customer support information from the customer support session; and
communicating the customer support report for the customer support session to the identified destination.

16. The one or more tangible processor-readable storage media of claim 15, wherein the customer support information for the customer support session includes a root cause indication provided by a support resource and an outcome indication provided by customer input.

17. The one or more tangible processor-readable storage media of claim 15, wherein the training data from some of the other customer support sessions are labeled with correct destinations for communicating customer support reports for the some of the other customer support sessions.

18. The one or more tangible processor-readable storage media of claim 15, wherein the training data from some of the other customer support sessions are not labeled with correct destinations for communicating customer support reports for the some of the other customer support sessions.

19. The one or more tangible processor-readable storage media of claim 15, wherein the collected customer support information includes a root cause indication qualified by customer input characterizing an outcome of that customer support session.

20. The one or more tangible processor-readable storage media of claim 15, wherein the identifying operation comprises:
identifying the destination for communicating the customer support report of the customer support session based on the routing score better satisfying a routing condition for the destination as compared to routing conditions of other available destinations.
